(19) United States
(12) Patent Application Publication
(10) Pub. No.: US 2007/0055414 A1
(43) Pub. Date: Mar. 8, 2007

(54) Method and system for configuring telematics control unit

(76) Inventor: Ankur K. Darji, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/221,695

(22) Filed: Sep. 8, 2005

(51) Int. Cl. G05D 1/00

(52) U.S. Cl. 701/2; 701/1

(57) ABSTRACT

The present invention provides a method and a system for configuring a telematics control unit (102) embedded in a vehicle (100). To configure the telematics control unit, a message containing a new set of configuration parameters is received by a device interface (202). The new set of configuration parameters is used by the telematics control unit to communicate with a second wireless communication device (204). Subsequently, the new set of configuration parameters is stored in a non-volatile memory (206) of the telematics control unit. The telematics control unit (102) is configured by using the new set of configuration parameters stored in the non-volatile memory of the telematics control unit (102). The telematics control unit (102) is configured to communicate with the second wireless communication device (204).

### FIELD OF THE INVENTION

The present invention relates generally to the field of telematics control units embedded in vehicles. In particular, the present invention relates to the configuration of telematics control units.

### BACKGROUND OF THE INVENTION

One of the fastest growing areas in communication technology involves telematics control units embedded in vehicles. A telematics control unit provides wireless communication functions such as unlocking the doors of a vehicle, disabling an alarm, determining the location of a vehicle, and accessing call-centre information.

A Cellular Phone Subsystem (CPS) plays an important role in a telematics control unit. The CPS provides the telematics control unit with a common set of application program interfaces, which enables the telematics control unit to communicate with one or more mobile phones. Every mobile phone has a set of configuration parameters such as an initial communication delay, a first power toggle response, a second power toggle response, a third power toggle response, and a power toggle response timeout. The configuration parameters and their values may vary from one type of mobile phone to another. The life of a typical mobile phone is less than that of a vehicle. Therefore, a user would like to change mobile phones more often than a vehicle. As a result, every time a user changes the mobile phone, a new telematics control unit software is required to support the new mobile phone.

### BRIEF DESCRIPTION OF THE DRAWINGS

The present invention is illustrated by way of example and not limitation in the accompanying figures, in which like references indicate similar elements, and in which:

FIG. 1 is a diagram illustrating an exemplary environment, where various embodiments of the present invention may be practiced;

FIG. 2 is a block diagram illustrating the components of a telematics control unit, in accordance with one embodiment of the present invention;

FIG. 3 is a flow diagram illustrating a method for configuring a telematics control unit, in accordance with one embodiment of the present invention.

FIG. 4 is a flow diagram illustrating a method for configuring a telematics control unit, in accordance with another embodiment of the present invention.

FIG. 5 is a flow diagram illustrating a method for initializing a telematics control unit, in accordance with an embodiment of the present invention.

FIG. 6 is a flow diagram illustrating a method for initializing a telematics control unit, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help to improve understanding of embodiments of the present invention.

### DETAILED DESCRIPTION OF THE DRAWINGS

In an embodiment of the present invention, a method for configuring a telematics control unit embedded in a vehicle is provided. To configure the telematics control unit, a message containing a new set of configuration parameters is received from a first wireless communication device. The new set of configuration parameters is used by the telematics control unit to communicate with a second wireless communication device. The new set of configuration parameters is stored in a non-volatile memory of the telematics control unit. The telematics control unit is configured by using the new set of configuration parameters stored in its non-volatile memory, to communicate with the second wireless communication device.

In another embodiment of the present invention, a method for initializing a telematics control unit embedded in a vehicle is provided. To initialize the telematics control unit, a set of default configuration parameters is read from a configuration file stored in the telematics control unit. After reading the set of default configuration parameters, it is determined whether a new set of configuration parameters exists in a non-volatile memory of the telematics control unit. If it does, it is read from the non-volatile memory. Then, the telematics control unit is initialized by using either the set of default configuration parameters or the new set of configuration parameters.

In yet another embodiment of the present invention, a telematics control unit embedded in a vehicle is provided. The telematics control unit includes a device interface, a non-volatile memory, and a controller. The device interface receives a message containing a new set of configuration parameters from a first wireless communication device. The new set of configuration parameters is used by the telematics control unit to communicate with a second wireless communication device. The device interface passes the new set of configuration parameters to the non-volatile memory. The device interface passes the new set of configuration parameters to the non-volatile memory with the help of the controller. The non-volatile memory stores the new set of configuration parameters. The controller is capable of reading the new set of configuration parameters stored in the non-volatile memory of the telematics control unit. Further, the controller also uses the new set of configuration parameters stored in the non-volatile memory to configure the telematics control unit, which is configured to communicate with the second wireless communication device.

Before describing in detail a method and system for configuring a telematics control unit, in accordance with the present invention, it should be observed that the present invention resides primarily in combinations of method steps and apparatus components related to the telematics control unit. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

In this document, relational terms such as first and second, top and bottom, and the like, may be used, solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element proceeded by “comprises . . . a” does not, without more constraints, preclude the existence of additional identical elements in the process, method, article or apparatus that comprises the element.

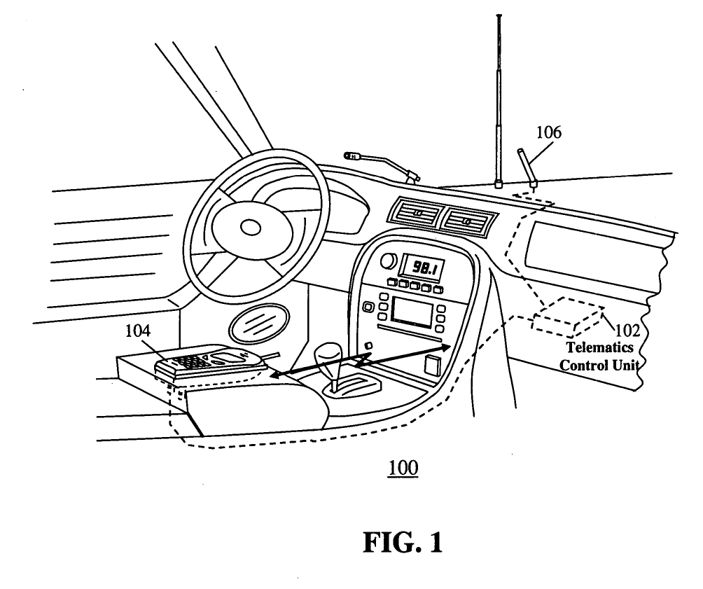

FIG. 1 is a diagram illustrating an exemplary environment where various embodiments of the present invention may be practiced. The environment includes a vehicle 100. The vehicle 100 includes a telematics control unit 102, a first wireless communication device 104, and an antenna 106.

As shown in FIG. 1, the telematics control unit 102 is configured to communicate with the first wireless communication device 104. In an embodiment of the present invention, the first wireless communication device 104 enables the telematics control unit 102 to access a wireless communication network (not shown in FIG. 1). In another embodiment of the present invention, a user may interact with the telematics control unit 102 by using the first wireless communication device 104. In one embodiment of the present invention, the antenna 106 enables a network access device (not shown in FIG. 1) to receive a message from a vehicle dealer.

In an embodiment of the present invention, the first wireless communication device 104 communicates with the telematics control unit 102 by using a wired connection. In another embodiment of the present invention, the first wireless communication device 104 communicates with the telematics control unit 102 through a wireless connection such as a short-range wireless communication protocol. Examples of suitable wireless communications protocols include, but are not limited to, Bluetooth™, Object Exchange Protocol (OBEX), HomeRF, 802.11, Wireless Area Protocol (WAP), Dedicated Short Range Communication (DSRC) system, and the like.

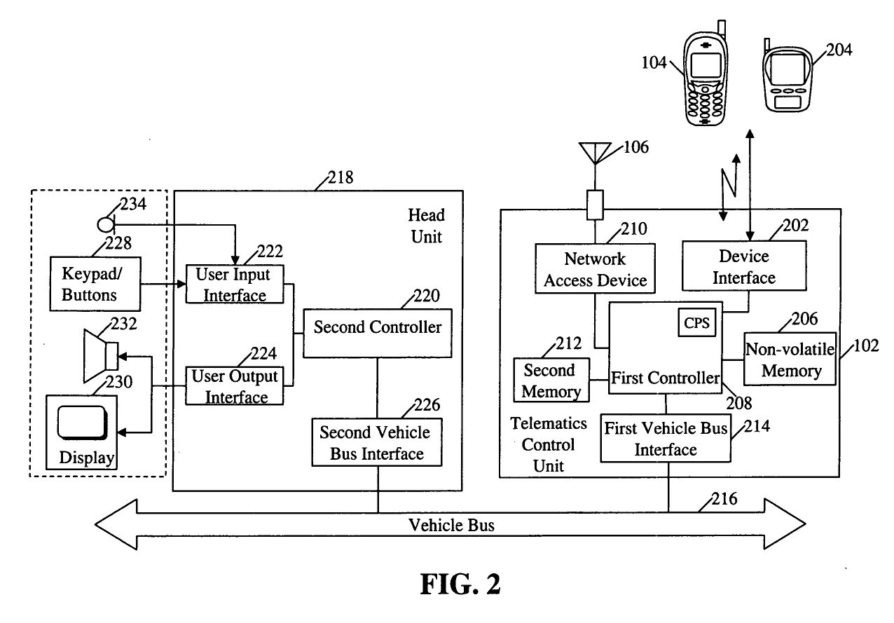

FIG. 2 is a block diagram illustrating the components of the telematics control unit 102, in accordance with one embodiment of the present invention. In one embodiment, the telematics control unit 102 includes a device interface 202, a non-volatile memory 206, a first controller 208, and a network access device 210.

The device interface 202 is configured to receive messages from the first wireless communication device 104. The device interface 202 may enable either a wired or wireless communication with the first wireless communication device 104. For instance, if the device interface 202 enables wireless communications, the device interface 202 may be a short-range wireless transceiver. In one embodiment of the present invention, a message received by the device interface 202 contains a new set of configuration parameters associated with a second wireless communication device 204. For instance, the new set of configuration parameters may include configuration parameters such as an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer. The new set of configuration parameters is used by the telematics control unit 102 to communicate with a second wireless communication device 204. In an embodiment of the present invention, the first wireless communication device 104 and the second wireless communication device 204 may be portable cellular phones. In another embodiment of the present invention, the first wireless communication device 104 may be the network access device 210 embedded in the vehicle 100, and the second wireless communication device 204 may be a portable cellular phone. Further, the network access device 210 is connected to the antenna 106. The antenna 106 enables the network access device 210 to receive the message from a remote center such as a dealer of the vehicle. In various embodiments of the present invention, the antenna 106 may be a dipole antenna, a 3rd-Generation (3G) antenna, or a tri-band antenna.

After the new set of configuration parameters associated with the second wireless communication device 204 is received by the device interface 202, it is stored in the non-volatile memory 206 of the telematics control unit 102. In various embodiments of the present invention, the non-volatile memory 206 may be an Erasable Programmable Read-Only Memory (EPROM), an Electrically Erasable Programmable Read-Only Memory (EEPROM), a Ferroelectric Random Access Memory (FRAM), and a Non Volatile Static Random Access Memory (NV SRAM). The first controller 208 reads the new set of configuration parameters stored in the non-volatile memory 206 of the telematics control unit 102. Further, the first controller 208 uses the new set of configuration parameters to configure the telematics control unit 102 to communicate with the second wireless communication device 204.

In one embodiment of the present invention, the first controller 208 is capable of reading the message received by the device interface 202 and storing the message in the non-volatile memory 206. Further, the first controller 208 confirms that the message contains the new set of configuration parameters before storing them in the non-volatile memory 206. In an embodiment of the present invention, the telematics control unit 102 also includes a second memory 212, to store the set of default configuration parameters. The first controller 208 uses the set of default configuration parameters to configure the telematics control unit 102 if the new set of configuration parameters is not stored in the non-volatile memory 206 of the telematics control unit 102.

In an embodiment of the present invention, the telematics control unit 102 may also include a first vehicle bus interface 214, which enables the telematics control unit 102 to access a vehicle bus 216. The vehicle bus 216, in turn, allows the telematics control unit 102 to communicate with a head unit 218 of the vehicle 100.

The head unit 218 includes a second controller 220, a user input interface 222, a user output interface 224, and a second vehicle bus interface 226. The head unit 218 allows a user of the telematics control unit 102 to provide an input to the telematics control unit 102. The head unit 218 also allows the telematics control unit 102 to provide an output to the user. The output may be an audio output, a video output or an audio-video output. The second controller 220 controls the functions of various modules of the head unit 218. The user input interface 222 enables the head unit 218 to accept the input. In one embodiment of the present invention, the input is provided through a keypad or buttons 228 and/or a microphone 234 that is associated with a voice recognition module in the user input interface 222. The user output interface 224 enables the head unit 218 to provide an output to a display device 230, an audio device 232, or to both. The second vehicle bus interface 226 enables the head unit 218 to access the vehicle bus 216.

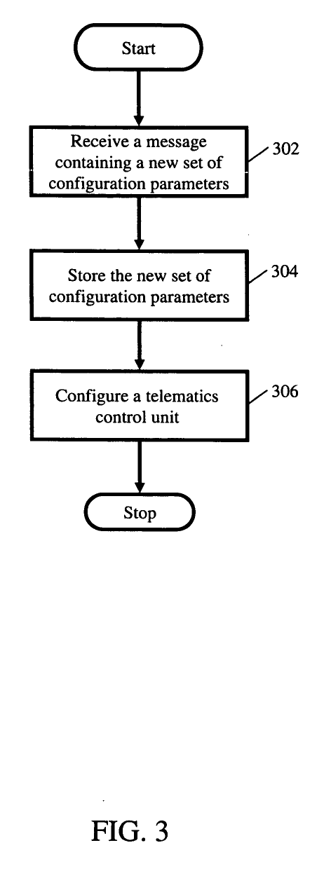

FIG. 3 is a flow diagram illustrating a method for configuring the telematics control unit 102, in accordance with one embodiment of the present invention. At step a 302, a message containing a new set of configuration parameters is received by the device interface 202. In an embodiment of the present invention, the message containing the new set of configuration parameters associated with a second wireless communication device 204 is received from the first wireless communication device 104. As described above, the device interface 202 may be configured to receive the message from the first wireless communication device 104 using a wired or wireless communication link. The new set of configuration parameters is used by the telematics control unit 102 to manage and communicate with the second wireless communication device 204. In an embodiment of the present invention, the first wireless communication device 104 and the second wireless communication device 204 may be portable cellular phones. In another embodiment of the present invention, the first wireless communication device 104 is the network access device 210 embedded in the vehicle 100, and the second wireless communication device 204 is a portable cellular phone. In an embodiment of the present invention, the new set of configuration parameters may include configuration parameters such as an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer. At step 304, the new set of configuration parameters is stored in the non-volatile memory 206 of the telematics control unit 102. At step 306, the telematics control unit 102 is configured by using the new set of configuration parameters stored in the non-volatile memory 206 of the Telematics control unit 102. In various embodiments of the present invention, the non-volatile memory 206 may be an Erasable Programmable Read-Only Memory (EPROM), an Electrically Erasable Programmable Read-Only Memory (EEPROM), a Ferroelectric Random Access Memory (FRAM), and a Non Volatile Static Random Access Memory (NV SRAM). The new set of configuration parameters is stored in the non-volatile memory 206 by the first controller 208. The telematics control unit 102 is configured to communicate with the second wireless communication device 204.

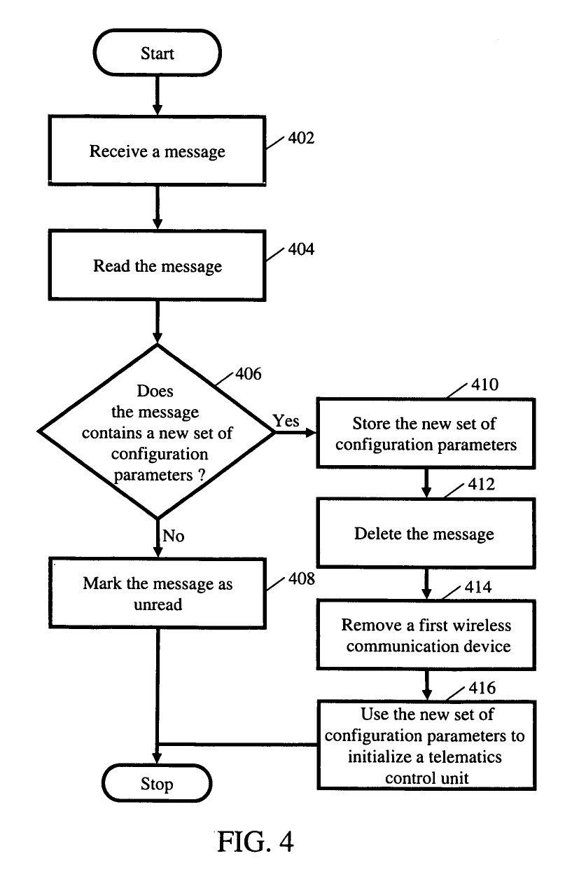

FIG. 4 is a flow diagram illustrating a method for configuring the telematics control unit 102, in accordance with another embodiment of the present invention. At step 402, a message is received by the device interface 202 from the first wireless communication device 104. As described above, the device interface 202 may be configured to receive the message from the first wireless communication device 104 using a wired or wireless communication link. At step 404, the first controller 208 reads the message. At step 406, it is determined whether the message contains a new set of configuration parameters. In an embodiment of the present invention, the first controller 208 determines whether the message contains the new set of configuration parameters associated with a second wireless communication device 204. At step 408, the message is marked as unread if it does not contain the new set of configuration parameters. In one embodiment of the present invention, the first controller 208 may mark the message as unread.

If the message contains the new set of configuration parameters, at step 410, the new set of configuration parameters that are associated with the second wireless communication device 204 is stored in the non-volatile memory 206 of the telematics control unit 102. The first controller 208 stores the new set of configuration parameters. At step 412, the message containing the new set of configuration parameters is deleted from the device interface 202. In one embodiment of the present invention, the first controller 208 may then delete the message containing the new set of configuration parameters. At step 414, the system may optionally be configured to remove the first wireless communication device 104 from the telematics control unit 102. The benefit of this step is to save memory space. At step 416, the telematics control unit 102 is initialized by using the new set of configuration parameters associated with the second wireless communication device 204. This will then allow the telematics control unit 102 to communicate with the second wireless communication device 204.

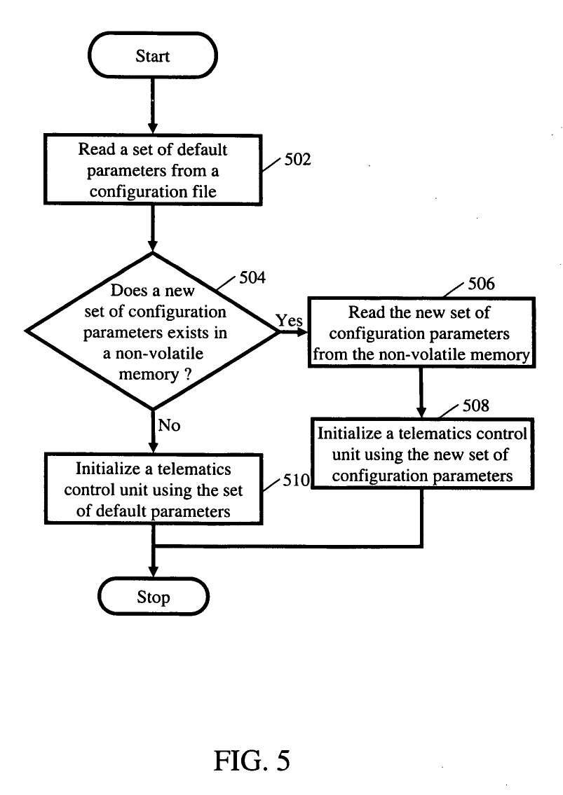

FIG. 5 is a flow diagram illustrating a method for initializing the telematics control unit 102, in accordance with one embodiment of the present invention. At step 502, the first controller 208 reads a set of default configuration parameters. The set of default configuration parameters is read from a configuration file stored in the telematics control unit 102. In one embodiment of the present invention, the configuration file is stored in the second memory 212 of the telematics control unit 102. As described above, the set of default configuration parameters may include configuration parameters such as an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer. Further, the first controller 208 reads the set of default configuration parameters. At step 504, it is determined whether a new set of configuration parameters associated with a second wireless communication device 204 exists in the non-volatile memory 206 of the telematics control unit 102. In one embodiment of the present invention, the new set of configuration parameters associated with the second wireless communication device 204 may include configuration parameters such as initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer.

If the new set of configuration parameters associated with a second wireless communication device 204 exists in the non-volatile memory 206 of the telematics control unit 102 then, step 506 is performed. At step 506, the new set of configuration parameters is read from the non-volatile memory 206 of the telematiccs control unit 102. At step 508, the telematics control unit 102 is initialized by using the new set of configuration parameters. In an embodiment of the present invention, the telematics control unit 102 is initialized to communicate with the second wireless communication device 204.

If the new set of configuration parameters associated with the second wireless communication device 204 does not exist in the non-volatile memory 206 of the telematics control unit 102, then step 510 is performed. At step 510, the telematics control unit 102 is initialized by using the set of default configuration parameters.

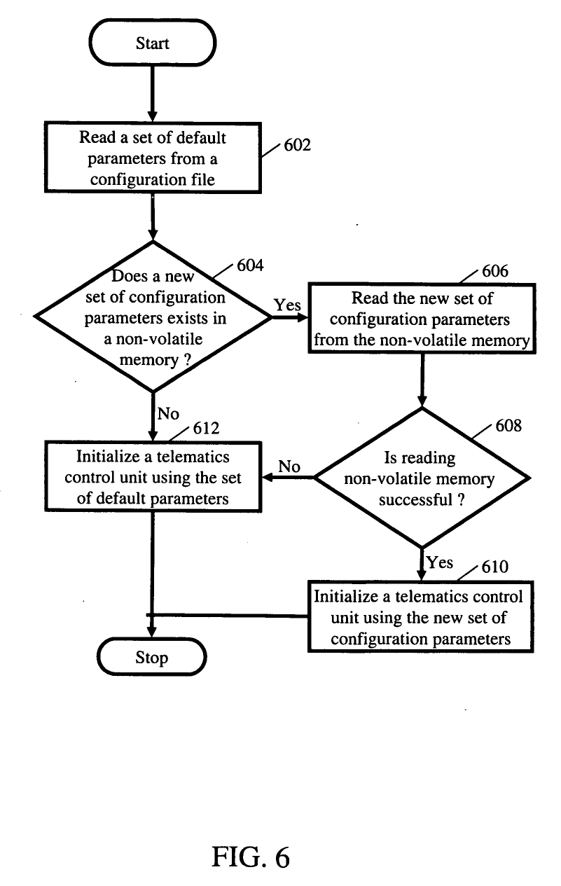

FIG. 6 is a flow diagram illustrating another method for initializing the telematics control unit 102. At step 602, the controller 208 reads a set of default configuration parameters. In an embodiment of the present invention, the set of default configuration parameters is read from a configuration file. In one embodiment of the present invention, the configuration file is stored in the second memory 214 of the telematics control unit 102. At step 604, it is determined whether a new set of configuration parameters associated with a second wireless communication device 204 exists in the non-volatile memory 206 of the telematics control unit 102.

If the new set of configuration parameters associated with the second wireless communication device 204 exists in the non-volatile memory 206 of the telematics control unit 102, then step 606 is performed. At step 606, the new set of configuration parameters is read from the non-volatile memory 206 of the telematics control unit 102. In an embodiment of the present invention, the first controller 208 reads the new set of configuration parameters associated with the second wireless communication device 204. At step 608, it is determined whether reading the new set of configuration parameters from the non-volatile memory 206 is successful. If it is successful, then step 610 is performed. At step 610, the telematics control unit 102 is initialized by using the new set of configuration parameters associated with the second wireless communication device 204. The telematics control unit 102 is now ready to communicate with the second wireless communication device 204.

If the new set of configuration parameters associated with the second wireless communication device 204 does not exist in the non-volatile memory 206, or reading the new set of configuration parameters from the non-volatile memory 206 is unsuccessful, then step 612 is performed. At step 612, the telematics control unit 102 is initialized by using the set of default configuration parameters from the configuration file. In an embodiment of the present invention, the telematics control unit 102 is initialized, to communicate with the second wireless communication device 204.

Various embodiments of the present invention provide a method and a system that allow a user of the telematics control unit 102 to easily change a portable cellular phone, e.g., that is being used in the vehicle 100, since a new telematics control unit software is not required. This is achieved by configuring a new portable cellular phone by using a new set of configuration parameters stored in the non-volatile memory 206 of the telematics control unit 102. The new set of configuration parameters is received by the device interface 202.

Various embodiments of the present invention provide a method and a system, which allow telematics control unit engineers and vehicle dealers to easily configure the telematics control unit 102 with a new portable cellular phone, without creating a new software release. The telematics control unit engineer may send a message, containing a new set of configuration parameters, to an existing portable cellular phone. The new set of configuration parameters may be stored in the non-volatile memory 206 of the telematics control unit 102. Further, the new set of configuration parameters may be used to configure the telematics control unit 102 to communicate with the new portable cellular phone.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required or essential features or elements of any or all the claims. The invention is defined solely by the appended claims, including any amendments made during the pendency of this application and all the equivalents of the claims, as issued.

What is claimed is:

1. A method for configuring a telematics control unit embedded in a vehicle, the method comprising:
receiving a message from a first wireless communication device, the message containing a new set of configuration parameters associated with communicating with a second wireless communication device;
storing the new set of configuration parameters associated with communicating with the second wireless communication device in a non-volatile memory of the telematics control unit; and
configuring the telematics control unit so that it is capable of communicating with the second wireless communication device using the new set of configuration parameters stored in the non-volatile memory.

2. The method of claim 1 wherein the new set of configuration parameters is selected from a group consisting of an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer.

3. The method of claim 1 wherein the first wireless communication device and the second wireless communication device are portable cellular phones.

4. The method of claim 1 wherein the first wireless communication device is a network access device embedded in the vehicle and the second wireless communication device is a portable cellular phone.

5. The method of claim 1 wherein the step of receiving the message from the first wireless communication device includes receiving a wireless communication message over a short-range communication protocol.

6. The method of claim 1 wherein the non-volatile memory is selected from a group consisting of an Erasable Programmable Read-Only Memory (EPROM), an Electrically Erasable Programmable Read-Only Memory (EEPROM), a Ferroelectric Random Access Memory (FRAM), and a Non Volatile Static Random Access Memory (NV SRAM).

7. The method of claim 1 further comprising the step of reading the message and confirming whether the message contains the new set of configuration parameters prior to the step of storing the new set of configuration parameters in the non-volatile memory.

8. A method for initializing a telematics control unit embedded in a vehicle, the method comprising:
reading a set of default configuration parameters from a configuration file, the configuration file being stored in the telematics control unit;
determining whether a new set of configuration parameters exists in a non-volatile memory of the telematics control unit;
reading the new set of configuration parameters if the new set of configuration parameters exists in the non-volatile memory; and
initializing the telematics control unit using at least one of the set of default configuration parameters and the new set of configuration parameters.

9. The method of claim 8 wherein the set of default configuration parameters and new set of configuration parameters are selected from a group consisting of an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer.

10. The method of claim 8 further comprising the step of determining whether reading of the new set of configuration parameters from the non-volatile memory is successful before the step of initializing the telematics control unit.

11. The method of claim 10 wherein the step of initializing the telematics control unit further comprises using the new set of configuration parameters for communicating with a second wireless communication device if reading of the new set of configuration parameters from the non-volatile memory is successful.

12. The method of claim 10 wherein the step of initializing the telematics control unit further comprises using the set of default configuration parameters for communicating with a second wireless communication device if reading of the new set of configuration parameters from the non-volatile memory is not successful.

13. A telematics control unit embedded in a vehicle, the telematics control unit comprising:
a device interface for receiving a message from a first wireless communication device, the message containing a new set of configuration parameters associated with communicating with a second wireless communication device;
a non-volatile memory for storing the new set of configuration parameters associated with communicating with the second wireless communication device; and
a first controller that is capable of reading the new set of configuration parameters stored in the non-volatile memory and using the new set of configuration parameters stored in the non-volatile memory to configure the telematics control unit so that the telematics control unit it is capable of communicating with the second wireless communication device.

14. The telematics control unit of claim 13 wherein the new set of configuration parameters are selected from a group consisting of an initial communication delay, a first power toggle response, a second power toggle response, a third power toggle response, a power toggle response timeout, a power toggle attempt, an initialization command, an initial command response, an initial command response timeout, an initial command attempt, a receiver response timeout, an initialization attempt, a powering timer, and a query timer.

15. The telematics control unit of claim 13 wherein the first wireless communication device and the second wireless communication device are portable cellular phones.

16. The telematics control unit of claim 13 wherein the first wireless communication device is a network access device embedded in the vehicle and the second wireless communication device is a portable cellular phone.

17. The telematics control unit of claim 13 wherein the device interface is a short range wireless transceiver.

18. The telematics control unit of claim 13 wherein the non-volatile memory is selected from a group consisting of an Erasable Programmable Read-Only Memory (EPROM), an Electrically Erasable Programmable Read-Only Memory (EEPROM), a Ferroelectric Random Access Memory (FRAM), and a Non Volatile Static Random Access Memory (NV SRAM).

19. The telematics control unit of claim 13 wherein the first controller is further capable of reading the message and confirming whether the message contains the new set of configuration parameters prior to storing the configuration parameters in the non-volatile memory.

20. The telematics control unit of claim 13 further comprising a second memory that stores the set of default configuration parameters, wherein the controller is capable of checking for the existence of a new set of configuration parameters in the non-volatile memory and if no new set of configuration parameters exist, then using the set of default configuration parameters to configure the telematics control unit.
